(19) United States
(12) Patent Application Publication
(10) Pub. No.: US 2015/0196446 A1
(43) Pub. Date: Jul. 16, 2015

(54) EASILY MOVABLE, FOLDING MASSAGE BED

(71) Applicant: Zhang Yue, Tian Huang Ping Town (CN)

(72) Inventor: Zhang Yue, Tian Huang Ping Town (CN)

(21) Appl. No.: 14/461,472

(22) Filed: Aug. 18, 2014

(30) Foreign Application Priority Data
Jan. 15, 2014 (CN) 201420024368.7

(51) Int. Cl. A61G 13/10; A61G 13/00

(52) U.S. Cl. CPC A61G 13/105; A61G 13/009; A61G 13/104

(57) ABSTRACT

An easily movable, folding massage bed comprising: a foldable plank having a upper top side, upper bottom side, lower top side, lower bottom side, left upper portion side, left lower portion side, right upper portion side, right lower portion side, a massage table portion and an underside; four foldable bed legs attached to the underside of the foldable plank; at least two roller seats attached to at least one of the upper top side, upper bottom side, lower top side, lower bottom side, left upper portion side, left lower portion side, right upper portion side, right lower portion side; and at least two rollers removably attached to the at least two roller seats.

This application claims priority to Chinese patent application number 201420024368.7 filed Jan. 15, 2014 and entitled “An easily movable, folding massage bed,” the entire contents of which are incorporated herein by reference.

The present invention relates to massage beds or tables.

Massage tables are often carried with the masseuse, who may travel to different locations. They are large and very heavy. Also, they must be kept clean and off of the ground. It would be very unappealing for a client to see that the massage table they are about to lay down on is dirty from being dragged on the ground.

Another problem is that once the masseuse arrives at their destination, the sides of the table must be smooth and cannot have protruding pieces. Any protrusion could catch the clothing or legs of the masseuse and interrupt their ability to perform a massage or even injure them.

The present invention seeks to solve these problems by providing a system that allows for the massage bed to be easily transported, with the table being off of the ground, optionally covered, and upon arrival not having any protruding parts providing a massage table that may be use without concern.

These and other features, aspects and advantages of the present invention will become better understood with reference to the following description and claims.

### SUMMARY OF THE INVENTION

The present invention relates generally to massage tables and massage table assemblies.

According to one embodiment, an easily movable, folding massage bed is provided comprising: a foldable plank having a upper top side, upper bottom side, lower top side, lower bottom side, left upper portion side, left lower portion side, right upper portion side, right lower portion side, a massage table portion and an underside; four foldable legs attached to the underside of the foldable plank; at least two roller seats attached to at least one of the upper top side, upper bottom side, lower top side, lower bottom side, left upper portion side, left lower portion side, right upper portion side, right lower portion side; and at least two rollers removably attached to the at least two roller seats.

According to another embodiment, an easily movable, folding massage bed is provided comprising: a foldable plank having a upper top side, upper bottom side, lower top side, lower bottom side, left upper portion side, left lower portion side, right upper portion side, right lower portion side, a massage table portion and an underside; four foldable bed legs attached to the underside of the foldable plank; at least two roller seats attached to at least one of the upper top side, upper bottom side, lower top side, lower bottom side, left upper portion side, left lower portion side, right upper portion side, right lower portion side; and at least one elongated bar with at least two wheels attached on opposing ends and having at least two openings corresponding to the location of the at least two roller seats; a connector having a male screw portion and a cap portion attached to the male screw portion to turn the male screw portion into the female screw thread through the at least two openings corresponding to the location of the at least two roller seats to removably attach and detach the at least one elongated bar to the at least two roller seats.

These and other features, aspects and advantages of the present invention will become better understood with reference to the following description and claims.

### BRIEF DESCRIPTION OF THE DRAWINGS

FIG. 1 depicts an elevational view of the present invention in an unfolded position;

FIG. 2 depicts a rear view of the present invention in an unfolded position;

FIG. 3 depicts a front view of the present invention in an unfolded position;

FIG. 4 depicts a right side view of the present invention in an unfolded position;

FIG. 5 depicts a left side view of the present invention in an unfolded position;

FIG. 6 depicts a top view of the present invention in an unfolded position;

FIG. 7 is a bottom view with the legs of the massage table in a folded position;

FIG. 8 depicts the roller seats according to the present invention;

FIG. 9 depicts cover with the wheel attached according to the present invention;

FIG. 10 depicts a roller according to one embodiment of the present invention;

FIG. 11 depicts a roller according to one embodiment of the present invention;

FIGS. 12-15 depict the roller seat according to one embodiment of the present invention;

FIG. 16 depicts a side view of the elongated bar according to the present invention;

FIG. 17 depicts a single wheel according to the present invention;

FIG. 18 depicts a top view of the elongated bar according to the present invention;

FIG. 19 depicts a bottom view of the elongated bar according to the present invention;

FIGS. 20-23 depict a connector according to the present invention; and

FIGS. 24-31 depict assembly according to one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

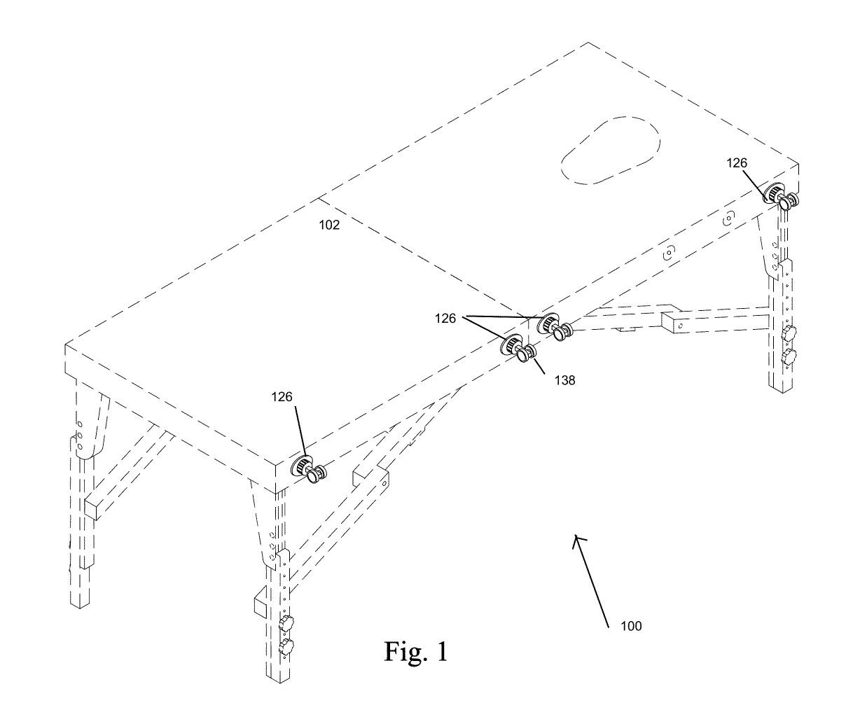

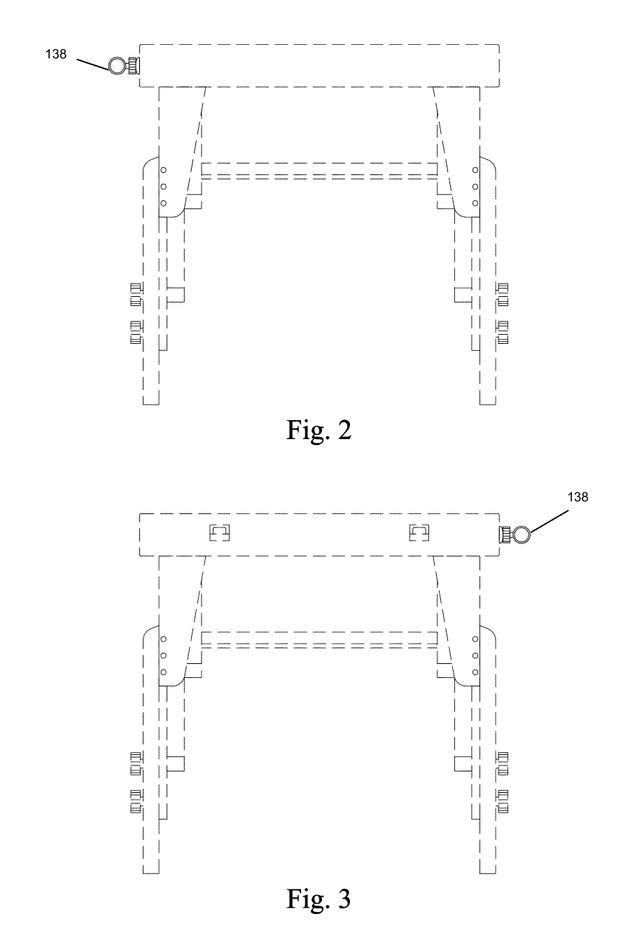

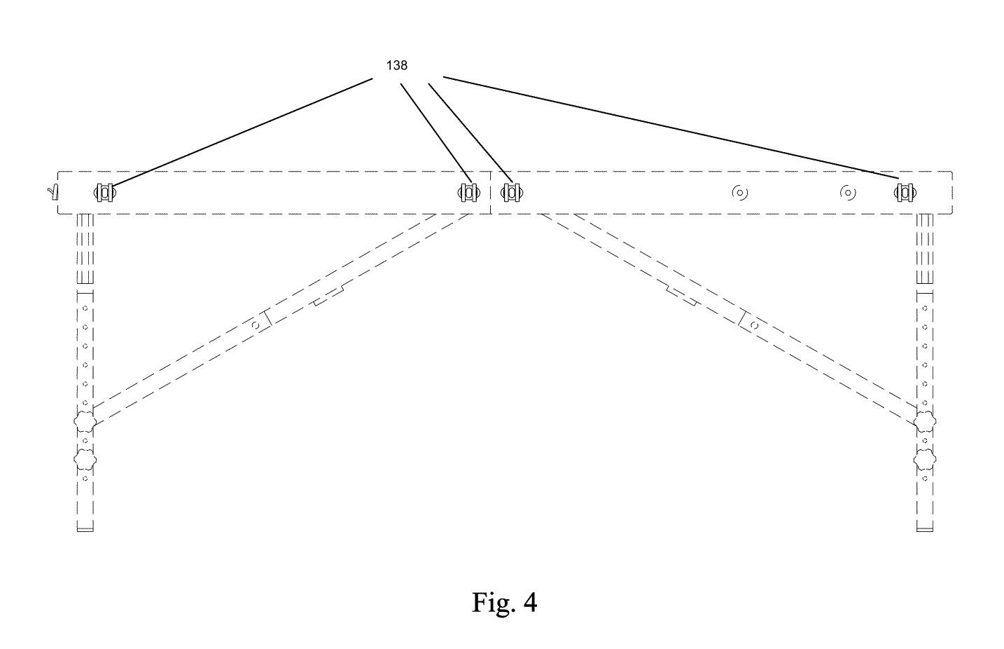

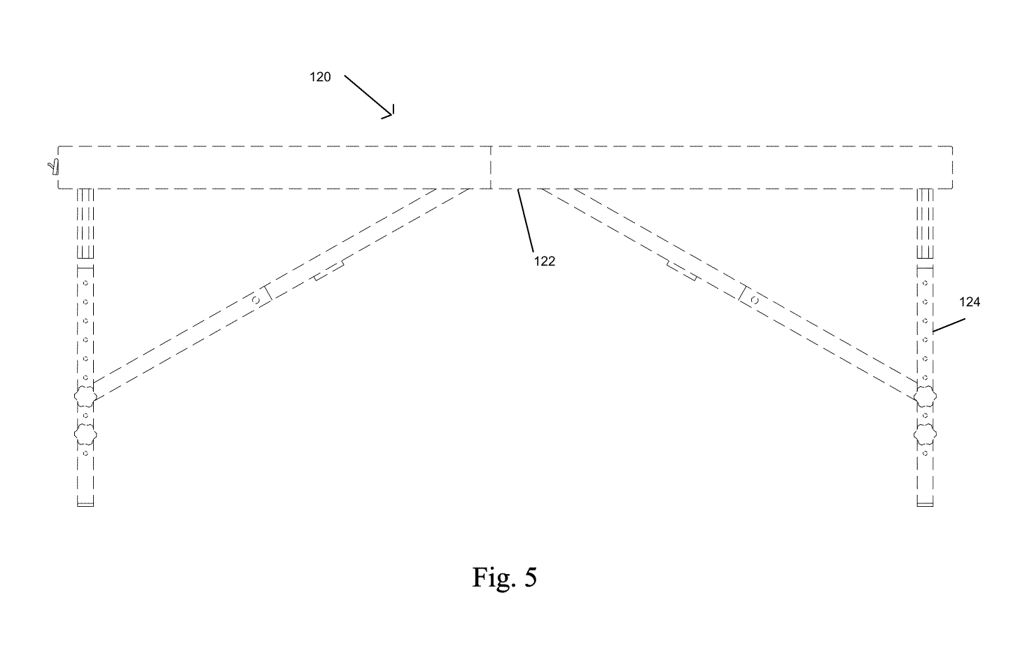

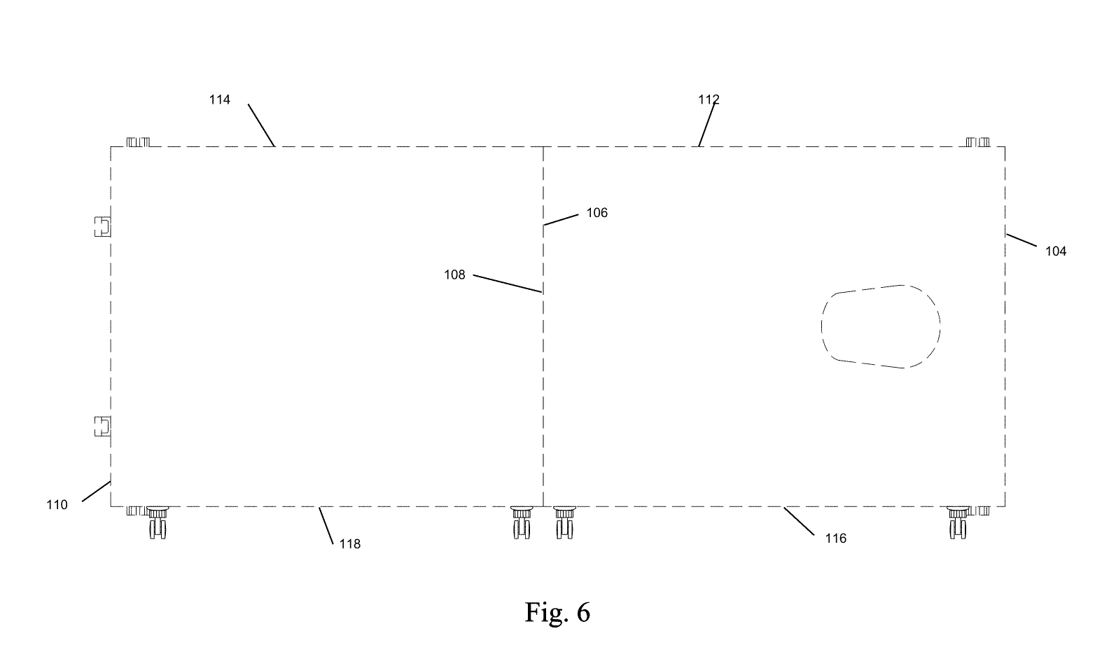

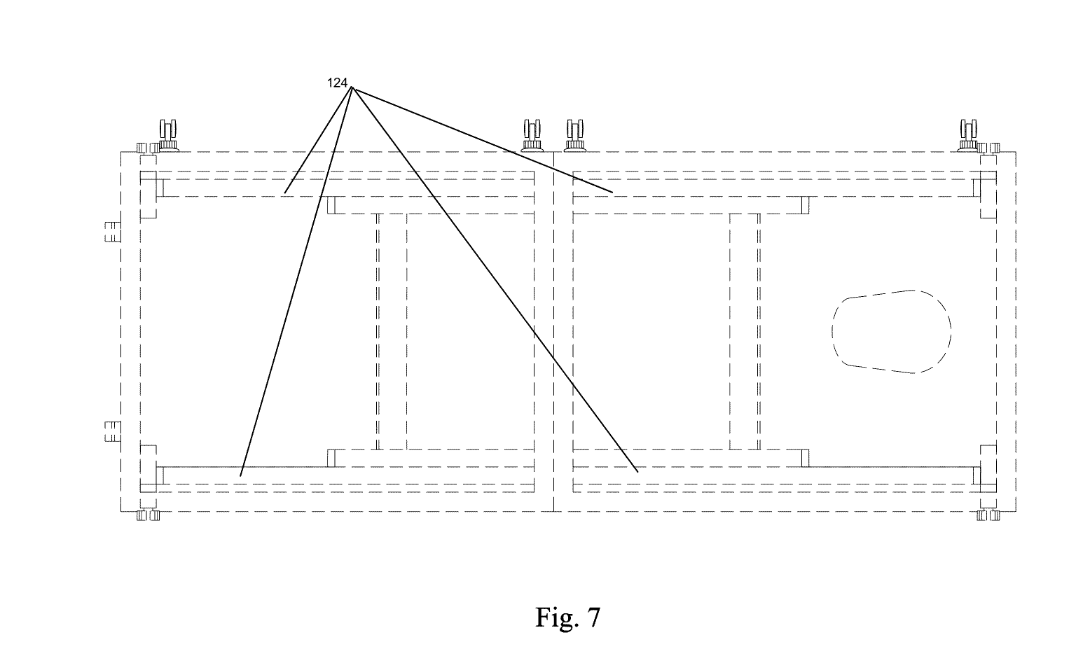

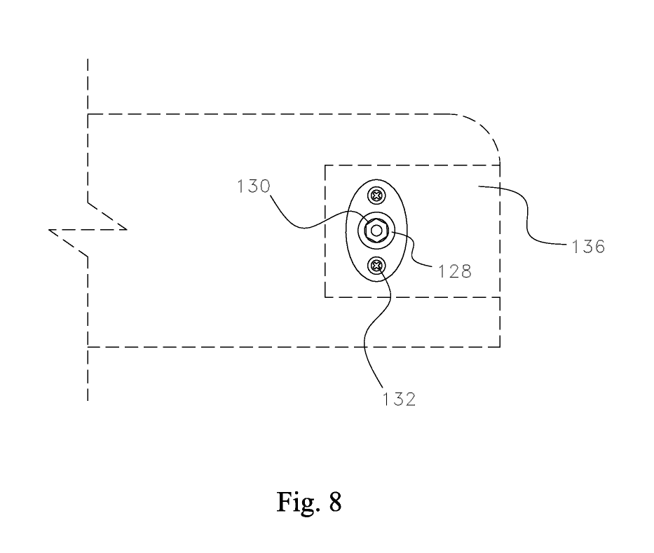

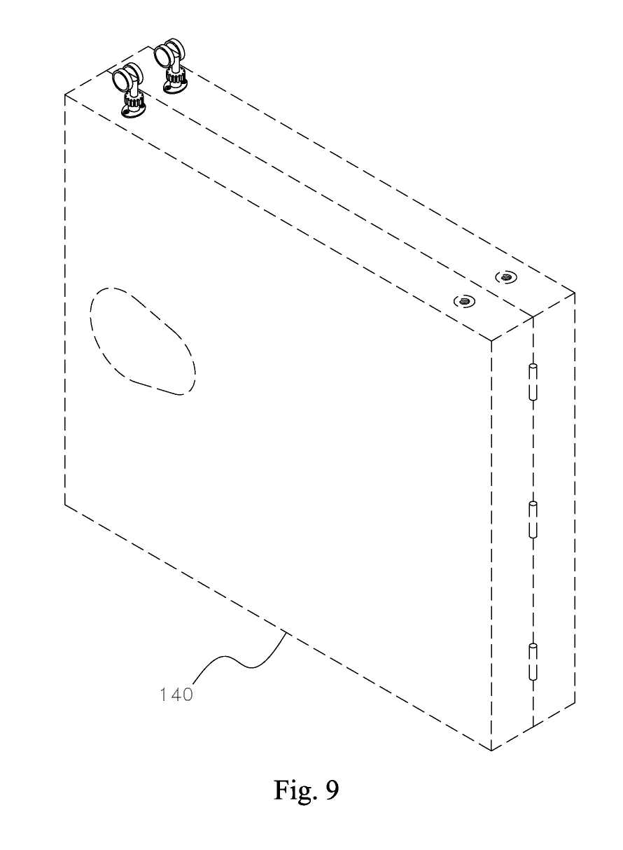

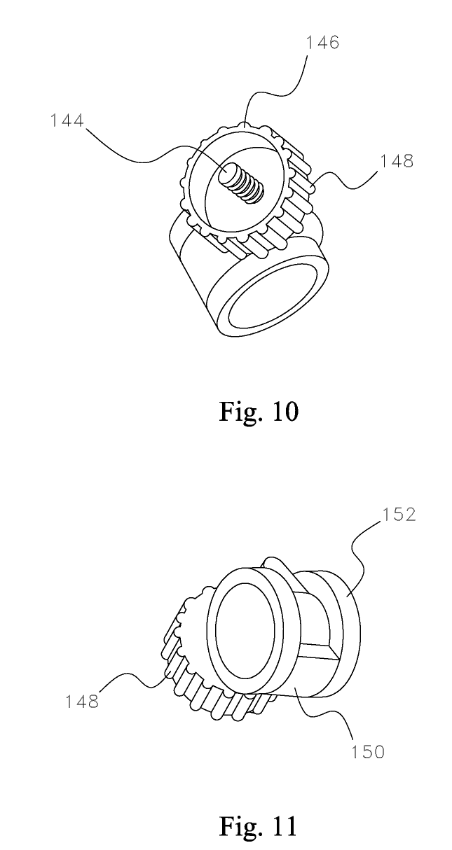

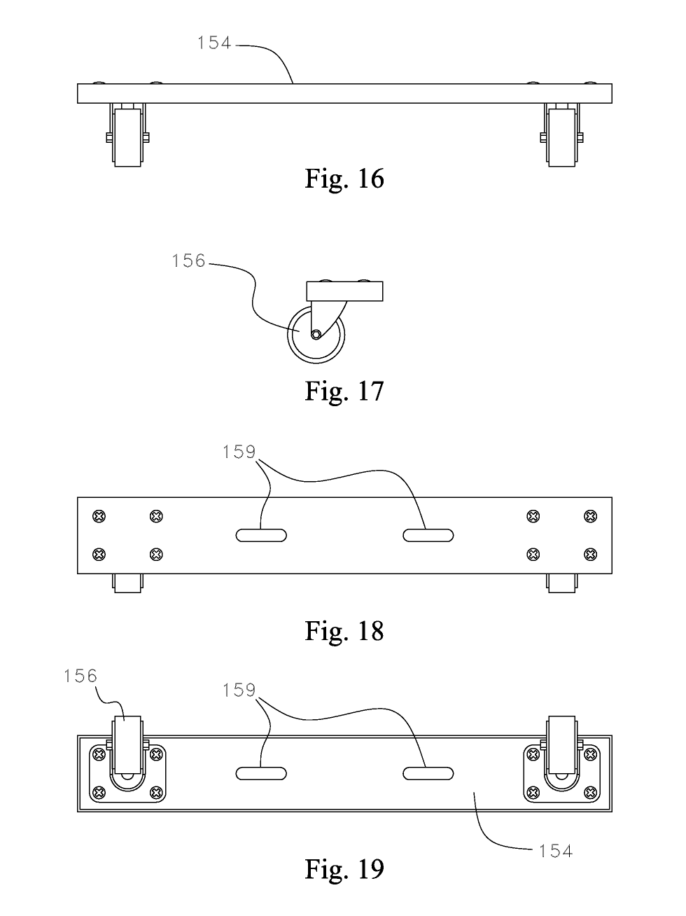

With reference to FIGS. 1-17, the present invention provides an easily movable, folding massage table (also referred to as massage bed) (100) comprising: a foldable plank (102) having a upper top side (104), upper bottom side (106), lower top side (108), lower bottom side (110), left upper portion side (112), left lower portion side (114), right upper portion side (116), right lower portion side (118), the massage table portion (120) which is the top of the foldable plank (102) and would be understood by one of ordinary skill in the art to be the portion of the massage table that the person being massaged lays down on. There is also an underside (122), which is the underneath portion of the table. There are four foldable legs (124) attached to the underside (122) of the foldable plank (102). There are at least two roller seats (126) attached to at least one of the upper top side, upper bottom side, lower top side, lower bottom side, left upper portion side, left lower portion side, right upper portion side, right lower portion side. FIG. 8 depicts one embodiment of a roller seat (126). As can be seen there is a raised cap (128) with a female screw thread (130). The raised cap (128) also serves the purpose of acting as a stand to keep the massage table removed from the floor when the rollers are not attached. The roller sear (126) may be attached to a portion of the folding massage bed by screws (132). FIG. 8 also depicts the cover (134) with openings (136) corresponding to the location of the at least two roller seats (126) and a zipper along a top the opposing side to the at least two roller seats (126). At least two rollers (138) removably attach (and detach) to the at least two roller seats (126). FIG. 9 depicts one embodiment of the at least two rollers attached to the at least two roller seats (126). As can be appreciated, the massage table (100) is in a folded position and the cover (134) is over the massage table. The zipper (142) is at least along a top the opposing side (140) to the at least two roller seats (126). In the example depicted, the zipper (142) is along the opposing side to the at least two roller seats and wraps around to a portion of the sides, to allow for a larger opening to get the massage table in and out. Note that FIGS. 1-4 depict an embodiment in which there are four roller seats (126) and four rollers (138) and they are attached to the right upper portion side (116) and the right lower portion side (118). This is an example. The roller seats (126) and the rollers (138) may be at least two and may be attached to any portion of the foldable plank (102) without departing from the present invention.

Each of the at least two rollers may have a male screw portion (144); a cap portion (146) attached to the male screw portion (144) to turn the male screw portion (144) into the female screw thread to removably attach and detach the at least two rollers to the at least two roller seats. There may also be a center post (150) attached to the top of the cap portion (146); and a wheel (152) attached to the center post. The wheel (152) may be a dual spinner wheel. This refers to the fact that a single wheel is made up of two wheels, as depicted in FIG. 11. The cap portion (146) may also be corrugated (148). This refers to the raised portions along the outer radius of the cap portion (146). These give the user a grip to turn the cap portion (146).

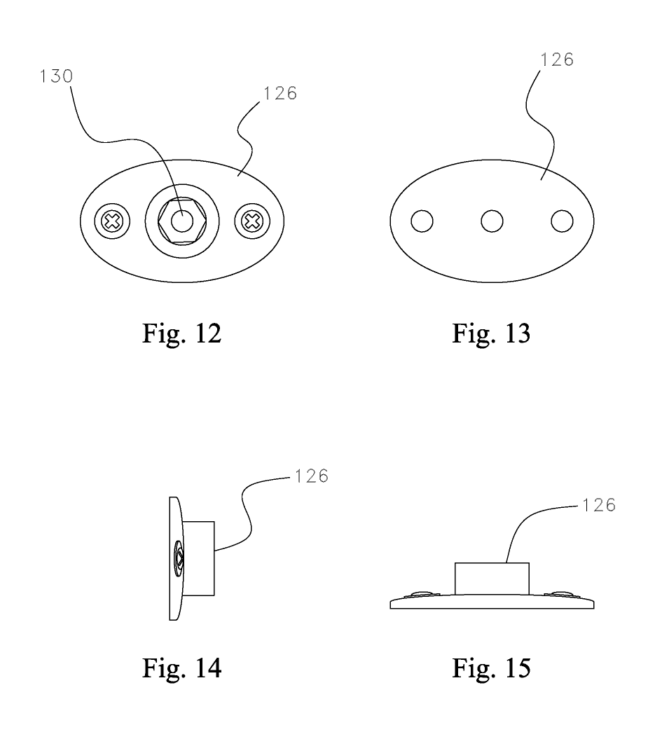

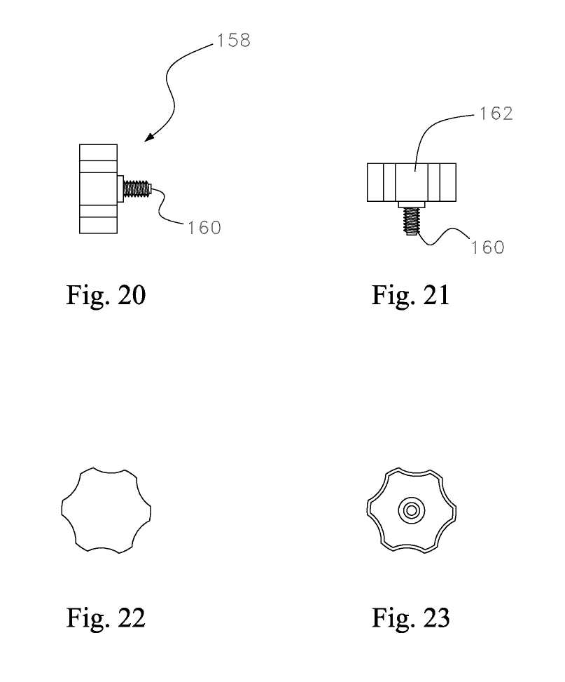

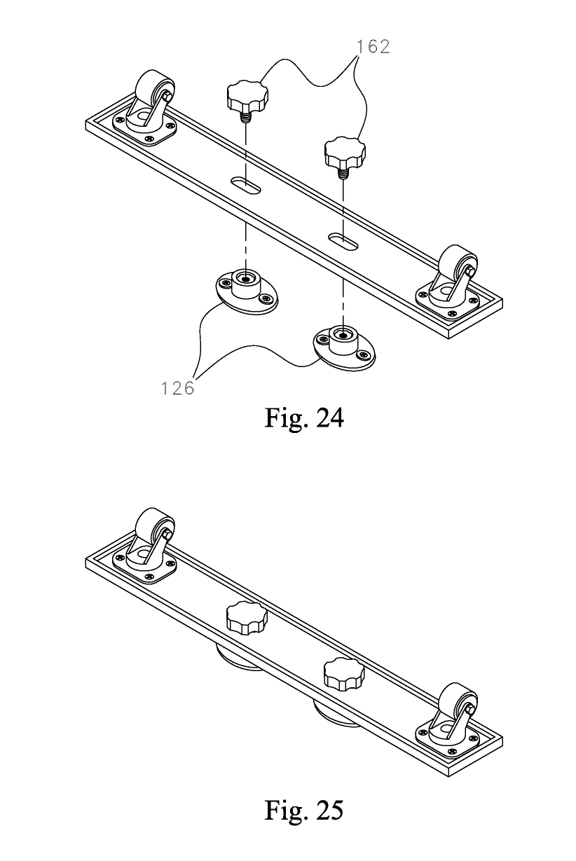

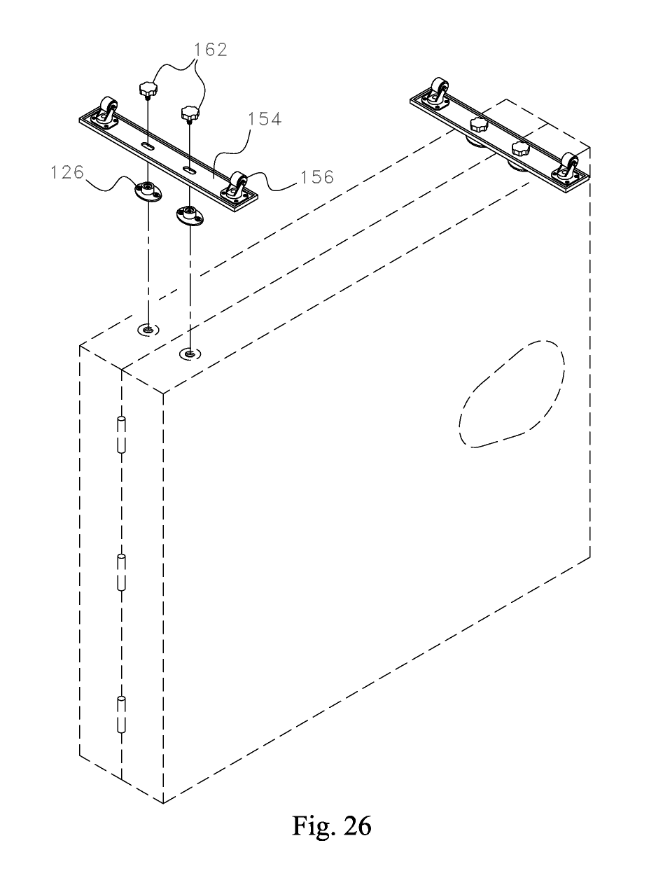

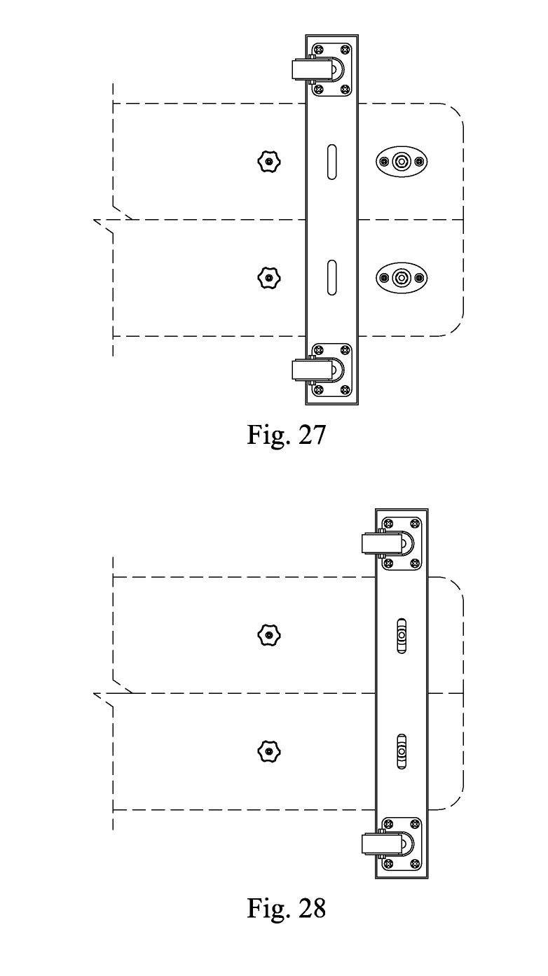

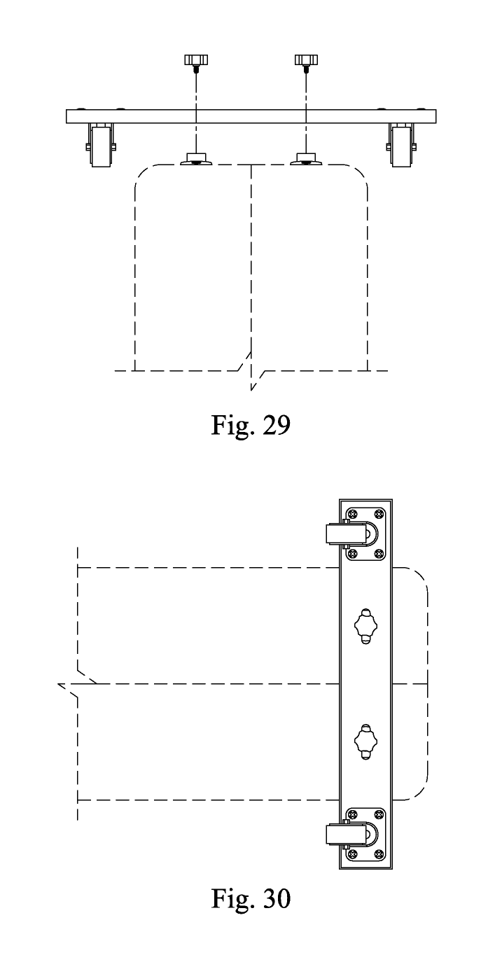

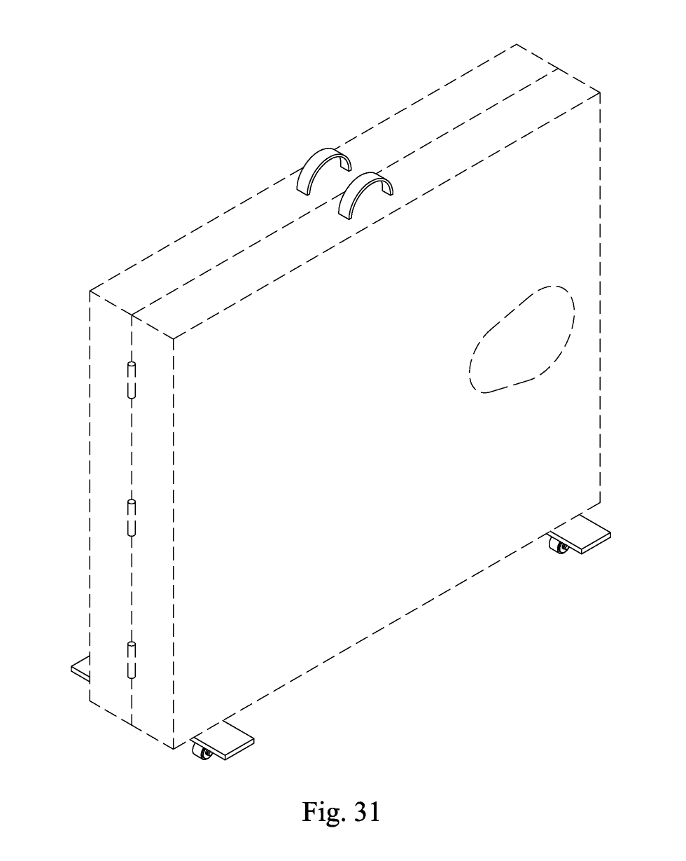

According to another embodiment, as depicted in FIGS. 12-31, the at least two rollers may be further comprising: at least one elongated bar (154) with at least two wheels (156) attached on opposing ends and having at least two openings (159) corresponding to the location of the at least two roller seats (126); a connector (158) having a male screw portion (160) and a cap portion (162) attached to the male screw portion (160) to turn the male screw portion (160) into the female screw thread (130) through the at least two openings (159) corresponding to the location of the at least two roller seats (126) to removably attach and detach the at least one elongated bar (154) with at least two wheels (156) to the at least two roller seats (126). FIG. 12 depicts a single spinner wheel (156). FIGS. 27-31 depict the elongated bar (154) being lined up with the female screw thread (130) in the roller seats (126) and the male screw portion (160) of the connector (158) removably attached to the female screw thread through the at least two opening (159).

It should be understood that the foregoing relates to preferred embodiments of the invention and that modifications may be made without departing from the spirit and scope of the invention as set forth in the following claims.

I claim:

1. An easily movable, folding massage bed comprising:
a foldable plank having a upper top side, upper bottom side, lower top side, lower bottom side, left upper portion side, left lower portion side, right upper portion side, right lower portion side, a massage table portion and an underside;
four foldable legs attached to the underside of the foldable plank;
at least two roller seats attached to at least one of the upper top side, upper bottom side, lower top side, lower bottom side, left upper portion side, left lower portion side, right upper portion side, right lower portion side; and
at least two rollers removably attached to the at least two roller seats.

2. An easily movable, folding massage bed as in claim 1, wherein each of the at least two roller seats is a raised cap with a female screw thread.

3. An easily movable, folding massage bed as in claim 2, wherein each of the at least two rollers are further comprising:
a male screw portion;
a cap portion attached to the male screw portion to turn the male screw portion into the female screw thread to removably attach and detach the at least two rollers to the at least two roller seats;
a center post attached to the top of the cap portion; and
a wheel attached to the center post.

4. An easily movable, folding massage bed as in claim 1, further comprising a cover with openings corresponding to the location of the at least two roller seats and a zipper along a top the opposing side to the at least two roller seats.

5. An easily movable, folding massage bed as in claim 2, wherein the at least two rollers are further comprising:
at least one elongated bar with at least two wheels attached on opposing ends and having at least two openings corresponding to the location of the at least two roller seats;
a connector having a male screw portion and a cap portion attached to the male screw portion to turn the male screw portion into the female screw thread through the at least two openings corresponding to the location of the at least two roller seats to removably attach and detach the at least one elongated bar to the at least two roller seats.

6. An easily movable, folding massage bed as in claim 3, wherein the wheel is a dual spinner wheel.

7. An easily movable, folding massage bed as in claim 3, wherein the wheel is a single spinner wheel.

8. An easily movable, folding massage bed as in claim 5, wherein the at least two wheels are dual spinner wheels.

9. An easily movable, folding massage bed as in claim 3, wherein the cap portion is corrugated.

10. An easily movable, folding massage bed as in claim 5, wherein the cap portion is corrugated.

11. An easily movable, folding massage bed comprising:
a foldable plank having a upper top side, upper bottom side, lower top side, lower bottom side, left upper portion side, left lower portion side, right upper portion side, right lower portion side, a massage table portion and an underside;
four foldable bed legs attached to the underside of the foldable plank;
at least two roller seats attached to at least one of the upper top side, upper bottom side, lower top side, lower bottom side, left upper portion side, left lower portion side, right upper portion side, right lower portion side; and
at least one elongated bar with at least two wheels attached on opposing ends and having at least two openings corresponding to the location of the at least two roller seats;
a connector having a male screw portion and a cap portion attached to the male screw portion to turn the male screw portion into the female screw thread through the at least two openings corresponding to the location of the at least two roller seats to removably attach and detach the at least one elongated bar to the at least two roller seats.

10. An easily movable, folding massage bed as in claim 10, wherein each of the at least two roller seats is a raised cap with a female screw thread.

11. An easily movable, folding massage bed as in claim 10, further comprising a cover with openings corresponding to the location of the at least two roller seats and a zipper along a top the opposing side to the at least two roller seats.

13. An easily movable, folding massage bed as in claim 10, wherein the wheel is a dual spinner wheel.

14. An easily movable, folding massage bed as in claim 10, wherein the wheel is a single spinner wheel.
